(19) United States
(12) Patent Application Publication
(10) Pub. No.: US 2007/0111717 A1
(43) Pub. Date: May 17, 2007

(54) ELECTRONIC PROGRAM GUIDE FOR MOBILE TV DEVICE

(75) Inventors: Ralf Mueller, Bellevue, WA (US); Chuanli Liu, Chapel Hill, NC (US); Leland Scott Bloebaum, Cary, NC (US)

Correspondence Address: MOORE AND VAN ALLEN PLLC FOR SEMC, P.O. BOX 13706, 430 DAVIS DRIVE, SUITE 500, RESEARCH TRIANGLE PARK, NC, 27709, US

(73) Assignee: SONY ERICSSON MOBILE COMMUNICATIONS AB, Lund (US)

(21) Appl. No.: 11/164,190

(22) Filed: Nov. 14, 2005

(51) Int. Cl. H04M 3/00

(52) U.S. Cl. 455/418

(57) ABSTRACT

A method and apparatus for operating an electronic program guide on a portable mobile communications device is presented. The portable mobile communications device is part of a larger network that is communicable with a mobile radio access network (MRAN) and capable of receiving broadcasts from a mobile television service provider. The portable mobile communications device displays a list of programs available and accepts input that selects one of the programs. This causes a display of the list of options that can be applied to the selected program. The portable mobile communications device then accepts input and performs the selected option for the selected program. The list of options includes an option to record the selected program locally, remotely, or on a home personal video recorder (PVR). In addition, list of options that can be applied to the selected program includes an option to set a reminder for the selected program.

### BACKGROUND OF THE INVENTION

The present invention relates to portable mobile communications devices and systems, and more particularly to a portable mobile communications device, system and method that can conveniently deliver audio/video content to a mobile device via an enhanced electronic program guide (EPG).

Portable mobile communications devices such as mobile phones are becoming more sophisticated and include many new features and capabilities. One such feature is the capability to receive mobile broadcast television signals or mobile television or the like, such as digital video broadcast-handheld (DVB-H), digital media broadcast (DMB), integrated services digital broadcast-terrestrial (ISDB-T), mobile broadcast multi-cast service (MBMS), or similar technologies. When integrated into a mobile phone, all of the aforementioned technologies utilize a separate mobile television tuner except for MBMS which can be received using the portable mobile communications device existing mobile radio receiver and transmitter.

A third party provider maintains the content or programs that can be viewed by a portable mobile device such as a mobile television equipped mobile phone. This content (i.e., programs) is made available to subscribers similar to a television network schedule. Thus, a viewer/subscriber can tune in to the content currently being broadcast. Unfortunately, this scheme only allows a viewer to see what is currently being broadcast. It does not provide for time shifting of viewing in which a viewer can watch a program that has already aired or preserve the ability to watch a future program just not at its originally scheduled broadcast time.

Currently, there are no provisions addressing the user's dilemma described above. What is needed is a mechanism that allows the viewer to selectively reserve the ability to watch programs on a time shifted basis that suits the viewer's schedule.

### BRIEF SUMMARY OF THE INVENTION

The present invention provides a method of operating an electronic program guide on a portable mobile communications device. The portable mobile communications device is part of a larger network that is communicable with a mobile radio access network (MRAN) and capable of receiving broadcasts from a mobile television service provider.

The portable mobile communications device displays a list of programs available on a default channel and accepts input from a user interface that selects one of the programs listed. This causes the portable mobile communications device to display a list of options that can be applied to the selected program. The options provide for multiple means for recording the selected program. The portable mobile communications device then accepts input from the user interface that selects one of the options for the selected program and performs the selected option for the selected program.

The list of options that can be applied to the selected program include an option to record the selected program locally on the portable mobile communications device, an option to record the selected program remotely on the mobile radio access network (MRAN), and an option to record the selected program remotely on a home personal video recorder (PVR) via an Internet connection among the mobile radio access network (MRAN), the mobile television service provider, and the home PVR.

In addition, list of options that can be applied to the selected program includes an option to set a reminder for the selected program. The reminder will be displayed, on the display of the portable mobile communications device, at a pre-determined time prior to the scheduled time of broadcast for the selected program.

The method described above can be implemented as software (i.e., an electronic program guide application) residing and executing within the portable mobile communications device. The electronic program guide application receives data and user interface input and causes the performance of the options described above via data communications with the appropriate devices using means of communication described herein.

### BRIEF DESCRIPTION OF THE DRAWINGS

FIG. 1 is a block diagram of an exemplary system for conveniently handling content from a mobile television device.

FIG. 2 is a block diagram of an exemplary portable mobile communications device for use within the system of FIG. 1 for conveniently handling content from a mobile television device.

FIG. 3 is a block diagram illustrating one embodiment of an electronic program guide top level display.

FIG. 4 is a block diagram illustrating one embodiment of an electronic program guide second level display.

FIG. 5 is a block diagram illustrating a mobile device display of stored programming with the location of the stored programming identified.

FIG. 6 is a flow chart describing a method of conveniently handling content from a mobile phone via an electronic program guide in accordance with an embodiment of the present invention.

### DETAILED DESCRIPTION OF THE INVENTION

The following detailed description of embodiments refers to the accompanying drawings, which illustrate specific embodiments of the invention. Other embodiments having different structures and operations do not depart from the scope of the present invention.

As will be appreciated by one of skill in the art, the present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium.

Any suitable computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

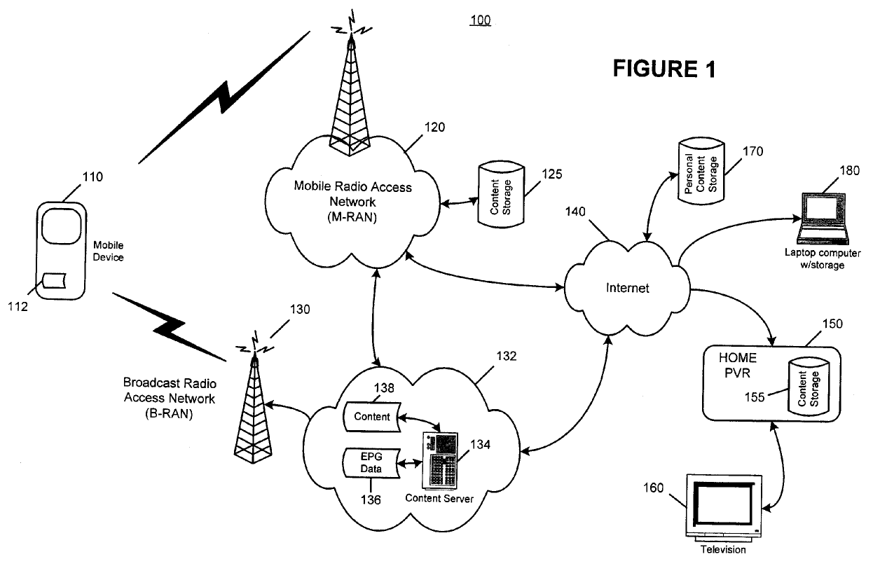

FIG. 1 is a block diagram of an exemplary system for conveniently handling content from a mobile television device. The system 100 may be a digital video broadcast-handheld (DVB-H), digital media broadcast (DMB), integrated services digital broadcast-terrestrial (ISDB-T), mobile broadcast multi-cast service (MBMS), or other similar technology. When integrated into a mobile phone, all of the aforementioned technologies utilize a separate mobile television tuner except for MBMS which can be received using the portable mobile communications device existing mobile radio receiver and transmitter.

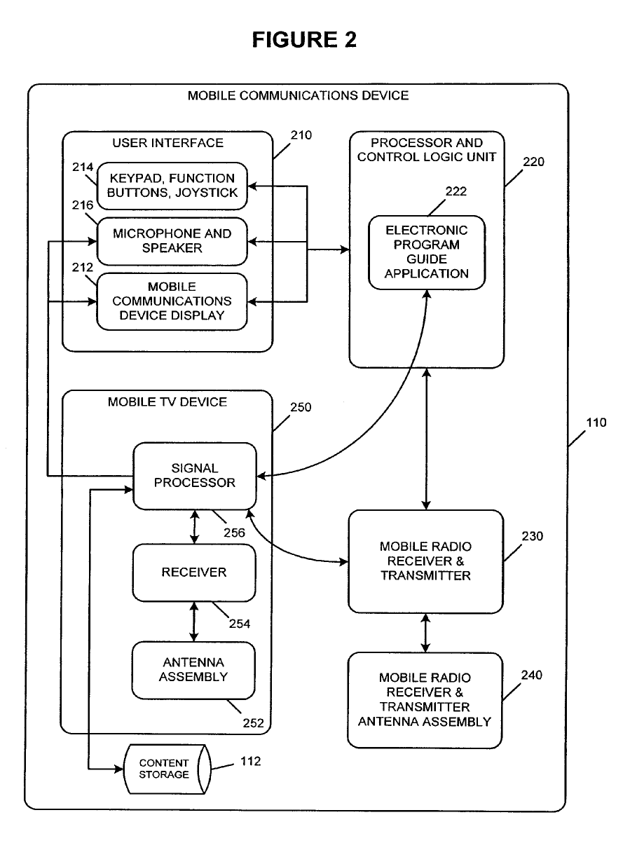

The portable mobile communications device 110 may be a cordless telephone, cellular telephone, personal digital assistant (PDA), communicator, computer device or the like and is not unique to any particular communications standard, such as Advanced Mobile Phone Service (AMPS), Digital Advanced Mobile Phone Service (D-AMPS), Global System for Mobile Communications (GSM), Code Division Multiple Access (CDMA) or the like. The design of the portable mobile communications device 110 illustrated in FIG. 2 is for purposes of explaining the present invention and the present invention is not limited to any particular design.

The portable mobile communications device 110 shown in FIG. 2 may include an operator or user interface 210 to facilitate controlling operation of the portable mobile communications device 110 including initiating and conducting phone calls and other communications. The user interface 210 may include a display 212 to provide visual signals to a subscriber or user as to the status and operation of the portable mobile communications device 110. The display 212 may be a liquid crystal display (LCD) or the like capable of presenting color images. The display 212 may provide information to a user or operator in the form of images, text, numerals, characters, a graphical user interface (GUI) and the like.

The user interface 212 may also include a keypad and function keys or buttons 214 including a pointing device, such as a joystick or the like. The keypad, function buttons and joystick 214 permit the user to communicate commands to the portable mobile communications device 110 to dial phone numbers, initiate and terminate calls, establish other communications, such as access to a mobile television provider, the Internet, send and receive email, text messages and the like. The keypad, function buttons and joystick 214 may also be used to control other operations of the portable mobile communications device 110. The keypad, function buttons and joystick 214 may also be implemented on a touch sensitive display adapted to receive tactile input.

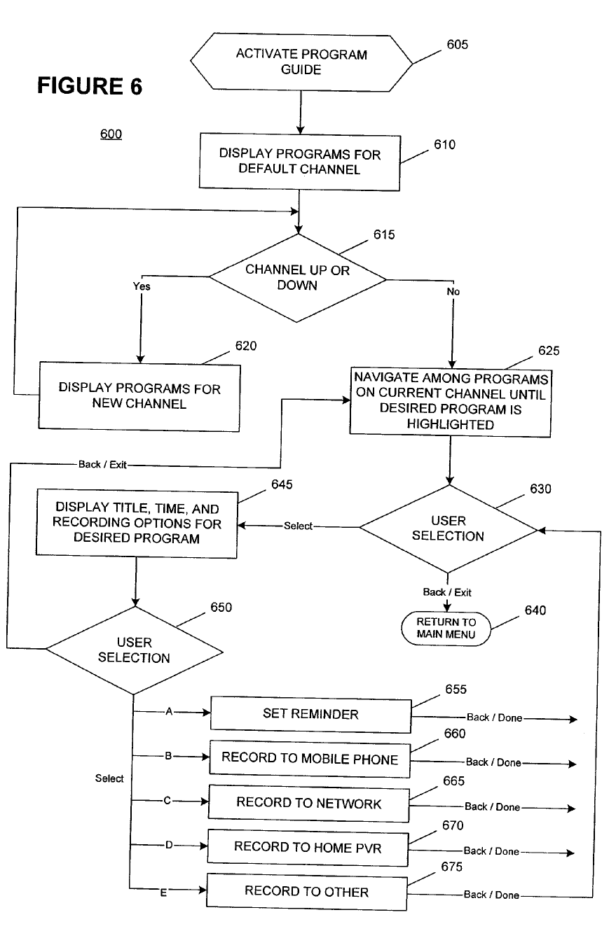

The display 212, keypad, and function buttons 214 may be coupled to a main processor and control logic unit 220. The processor and control logic unit 220 may be a microprocessor or the like. The processor and logic unit 220 may include an application 222 to set start and stop pointers corresponding to a content service provider. The functions and operations described with respect to a portable mobile communications device 110 in method 600 of FIG. 6 may be embodied in the electronic program guide (EPG) application 222. The electronic program guide application 222 may be embodied in hardware, firmware, software (data structures) or combinations thereof. The processor and logic unit 220 may also include other data structures, software programs, computer applications and the like to encode and decode control signals; perform communication procedures and other functions as described herein.

The user interface 210 may also include a microphone and a speaker 216. The microphone 216 may receive audio or acoustic signals from a user or from another acoustic source. The microphone 216 may convert the audio or acoustic signals to electrical signals. The microphone 216 may be connected to the processor and logic unit 220 wherein the processor and logic unit 220 may convert the electrical signals to baseband communication signals. The processor and control logic unit 220 may be connected to a mobile radio transmitter and receiver 230 that may convert baseband signals from the processor and control logic unit 220 to radio frequency (RF) signals. The mobile radio transmitter and receiver 230 may be connected to an antenna assembly 240 for transmission of the RF signals to a communication medium or system, such as a mobile radio access network (MRAN) 120 or the like. Mobile radio transmitter and receiver 230 can also receive mobile television broadcasts according to the MBMS standard. In this scenario, the MRAN 120 acts as the mobile television service provider.

The antenna assembly 240 may receive RF signals over the air and transfer the RF signals to a radio receiver 230. The radio receiver 230 may convert the RF signals to baseband signals. The baseband signals may be applied to the processor and control logic unit 220 which may convert the baseband signals to electrical signals. The processor and control unit 220 may send the electrical signals to the speaker 216 which may convert the electrical signals to audio signals that can be understood by the user.

The portable mobile communications device 110 may also include a mobile television device 250. The mobile television device 250 may be a DVB-H type device or the like. The mobile television device 250 may be integrally formed as part of the portable mobile communications device 110 or may be a separate unit that may be connected and operate in association with the portable mobile communications device 110. The mobile television device 250 may include an antenna assembly 252 for receiving broadcast signals of programming from a mobile television broadcast network, broadcast radio access network (B-RAN) 130 or the like. A receiver 254 may be coupled to the antenna assembly 252 to receive the broadcast signals. A signal processor 256 may receive the broadcast signals from the receiver 254 and convert the signals to a format for presentation on the display 212 of the portable mobile communications device 110. Or, a signal processor 230 may receive the broadcast signals from the receiver 254 and convert the signals to a format for presentation on the display 212 of the portable mobile communications device 110. Portable mobile communications device 110 also includes storage means 112 for storing content received by mobile television device 250. Storage means 1112 can be any number of internal storage devices or a removable storage medium such as compact flash card, memory stick, or the like.

The B-RAN 130 may originate the mobile television or DVB-H broadcast signals for broadcasting to communications devices or mobile television devices, such as portable mobile communications device 110 and mobile television device 250. The B-RAN 130 may include a transmitter to transmit the broadcast signals.

The B-RAN 130 may be connected to a mobile television service provider 132. The mobile television service provider 132 may originate programming for broadcasting to communications devices 110 or mobile television devices 250 via the B-RAN 130. The mobile television service provider 132 may include a content server 134 for hosting and managing content (e.g., programs from third party broadcasters such as ESPN, HBO, CNN, etc.). The content server 134 includes content storage 138 and electronic program guide data 136 representative of the content available to a subscriber. The electronic program guide data 136 is sent or broadcast to subscribers so that subscribers can determine what programming is available and when on their mobile television devices 250.

The mobile television service provider 132 and the M-RAN 120 are communicable with one another for the purpose of allowing the combination portable mobile communications device 110/mobile television device 250 to send data to the mobile television service provider 132 through M-RAN 120. It can be a direct connection between mobile television service provider 132 and M-RAN 120 or both can be connected to the Internet 140 which can act as bridge for data communications. In addition, a home personal video recorder (PVR) 150 including storage means 155 can be in communication with the Internet 140 thereby allowing the transfer of data among the portable mobile communications device 110, M-RAN 120, mobile television service provider 132, and the home personal video recorder (PVR) 150. Another storage option is an Internet personal storage 170 mechanism such as reserved space from an Internet service provider (ISP) that is accessible via the Internet 140. Yet another storage option is a laptop or notebook computer 180 with its own storage ability that is accessible to the Internet 140.

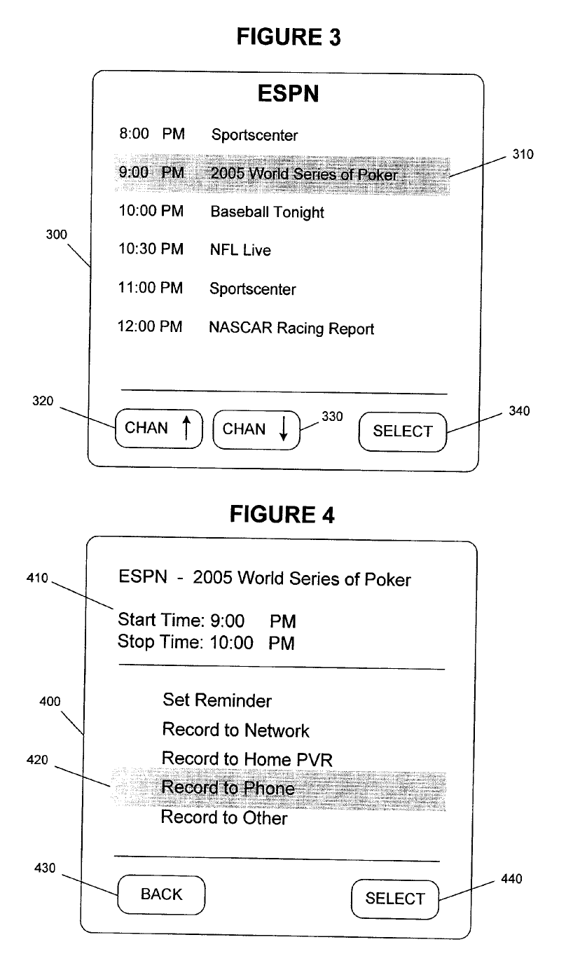

FIG. 3 is a block diagram illustrating one embodiment of an electronic program guide top level display 300. The electronic program guide top level display 300 is set up as a list of programs for a selected ‘channel’. A channel typically represents an individually tunable source of content that is but one of many other content sources that the user can subscribe to and receive via the mobile television device 250. Examples of channels include ESPN, HBO, CNN, etc.

In the present example, ESPN is the channel for which programming is displayed. Programs are listed according chronologically to allow the user to scan from the present time forward to see if there are any programs of interest. The user utilizes the user interface tools earlier described to navigate the screen. Currently, the user has scrolled or navigated to the “9:00 PM 2005 World Series of Poker” item 310 in the list. This is discernable because the currently selected program is highlighted or otherwise made to stand out on the display with respect to the other programs listed. In addition to the list of programs, the display also shows function keys 320, 330 to assist in displaying programs on other channels as well as a ‘select’ key 340 that will select the highlighted program and launch a secondary display as shown in FIG. 4 that will allow the user select viewing and recording options for the desired program. The function keys 320, 330, and 340 may be implemented as soft keys meaning that an actual key must be pressed on the user interface in order to invoke the function described on the display. The soft key method is generally used because it reduces the need for specific ‘hard’ keys since a soft key can be reconfigured to a new function yet still use the same hard key to invoke that function.

FIG. 4 is a block diagram illustrating one embodiment of an electronic program guide second level display 400. This is the screen display that will appear if the user selects the ‘select’ function key from FIG. 3. This secondary screen display 400 provides the user with information 410 pertaining to the selected program. Information 410 includes the channel and the start and stop time of the program's broadcast. Secondary screen display 400 also lists reminder and recording options for the selected program as well as function keys for returning to the previous display screen (back 430) or selecting a reminder or recording option (select 440). In this example the user has navigated to the ‘record to phone’ option 420.

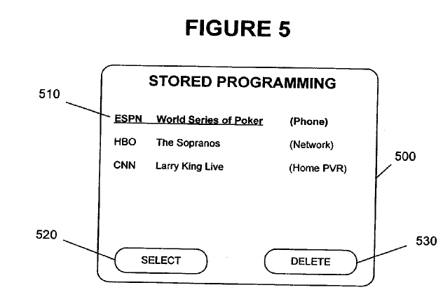

FIG. 5 is a block diagram illustrating a mobile device display of stored programming with the location of the stored programming identified. When a user wants to watch one of the programs he has previously stored, he navigates to a “Stored Programming” screen (or the like). This screen displays the programs currently available to view even though they have already aired live. In this example, the viewer can select from three stored programs. The programs in the list do not necessarily represent content that is stored locally. In fact, only the “ESPN World Series of Poker” item 510 is stored locally on the portable mobile communications device. The other two selections are stored on the M-RAN 120 and the user's home PVR 150. From this screen the user can manipulate the programs listed. Manipulation includes the ability view 520 programs that are locally stored or stored on the M-RAN network as well as delete 530 programs already viewed or no longer desired. While not shown, other forms of program manipulation can include the ability to play, pause, fast forward, or rewind the program.

It should also be noted that descriptions of the appearances of menus, lists, screen shots, and the like are merely illustrative. One of ordinary skill in the art can change the ‘look and feel’ of the user interface without affecting the scope of the present invention.

FIG. 6 is a flow chart describing a method of conveniently handling content from a mobile phone via an electronic program guide in accordance with an embodiment of the present invention. In block 605, the user activates the electronic program guide application. This causes, in block 610, the portable mobile communications device to display the programs for the default channel according to the screen display shown in FIG. 3. The default channel can be a user defined favorite channel, the last channel used by the user, on one end of the channel spectrum offered by the mobile television service provider, or determined in some other manner. In block 615 the portable mobile communications device waits for input to see if the user wishes to change channels either up or down to reveal programs available on another channel. If input is received indicating that the user wishes to see programs for another channel, the electronic program guide application will display the programs for the newly selected channel in block 620. The portable mobile communications device again waits for input to see if the user wishes to change channels. Otherwise, the user will, in block 625, navigate among the programs listed for the current channel until a desired program is highlighted. The portable mobile communications device then waits for user input again in block 630. The user can opt to go back or exit causing the display to return to the main menu of the electronic program guide application 640. Or, the user can ‘select’ the highlighted program which will cause, in block 645, the screen display of FIG. 4 to appear showing program information and recording options for the selected program. The portable mobile communications device again waits for user input in block 650. The user can opt to go back or exit causing the display to return to the list of programs shown in block 625. Or the user can select from one of the reminder or recording options.

In the present example there are four options. The first option shown in block 655 allows the user to set a reminder for a specific program. The reminder option accesses the portable mobile communications device calendar function and creates an alert to ‘pop up’ a specified time prior to the airing of the program. Once the reminder has been set, the user can return to the screen display shown in FIG. 4 for additional options.

The second option shown in block 660 allows the user to record and store the program locally to the portable mobile communications device. Selection of this option will cause the mobile television device to tune to the selected channel at the appropriate time to receive the desired program. The program will then be stored locally so that it can be viewed at a later time. Local storage is advantageous because the program can then be viewed without a connection to the M-RAN. For example, a user can view locally stored programming while on a flight when they are prohibited from connecting the portable mobile communications device with the M-RAN.

The third option shown in block 665 allows the user to record and store the program remotely on the M-RAN. Selection of this option will cause the mobile television device to send instructions to the M-RAN to obtain and store the desired program from the mobile television service provider. The program can be viewed at a later time by establishing a connection with the M-RAN from the portable mobile communications device. Remote storage is advantageous because the M-RAN presumably has a greater storage capacity than the portable mobile communications device.

The fourth option shown in block 670 allows the user to cause the program to be routed from the mobile television service provider to the user's home PVR. With this option, the user can view the program on a larger display at home.

Any prompts associated with the invention may be presented and responded to via an interactive voice feature, a graphical user interface (GUI) presented on the display of the portable mobile communications device or the like.

The flowcharts and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Although specific embodiments have been illustrated and described herein, those of ordinary skill in the art appreciate that any arrangement which is calculated to achieve the same purpose may be substituted for the specific embodiments shown and that the invention has other applications in other environments. This application is intended to cover any adaptations or variations of the present invention. The following claims are in no way intended to limit the scope of the invention to the specific embodiments described herein.

What is claimed is:

1. A method of operating an electronic program guide on a portable mobile communications device, the portable mobile communications device communicable with a mobile radio access network (MRAN) and capable of receiving content from a mobile television service provider, the method comprising:
displaying, on the display of the portable mobile communications device, a list of programs available on a channel;
accepting input from a user interface that selects one of the programs listed;
displaying, on the display of the portable mobile communications device, a list of options that can be applied to the selected program wherein the options provide for multiple means for storing the selected program;
accepting input from a user interface that selects one of the options for the selected program; and
performing the selected option for the selected program.

2. The method of claim 1 wherein the list of options that can be applied to the selected program includes an option to store the selected program locally on the portable mobile communications device.

3. The method of claim 1 wherein the list of options that can be applied to the selected program includes an option to store the selected program remotely on the mobile radio access network (MRAN).

4. The method of claim 1 wherein the list of options that can be applied to the selected program includes an option to store the selected program remotely on a home personal video recorder (PVR) via an Internet connection among the mobile radio access network (MRAN), the mobile television service provider, and the home PVR.

5. The method of claim 1 wherein the list of options that can be applied to the selected program includes an option to store the selected program remotely on an Internet storage device via an Internet connection among the mobile radio access network (MRAN), the mobile television service provider, and the home PVR.

6. The method of claim 1 wherein the list of options that can be applied to the selected program includes an option to store the selected program remotely on a computer via an Internet connection among the mobile radio access network (MRAN), the mobile television service provider, and the home PVR.

7. The method of claim 1 wherein the list of options that can be applied to the selected program includes an option to set a reminder for the selected program, the reminder to be displayed, on the display of the portable mobile communications device, at a pre-determined time prior to the scheduled time of delivery for the selected program.

8. The method of claim 1 wherein the channel can be changed via input from the user interface such that a new program list for a different channel can be displayed.

9. A portable mobile communications device capable of receiving and displaying an electronic program guide and broadcast programs from a mobile television service provider, the portable mobile communications device also communicable with a mobile radio access network (MRAN), the method comprising:
a mobile television device for receiving electronic program guide data and broadcast programs from the mobile television service provider;
storage means for storing electronic program guide data and programs provided by the mobile television service provider;
an electronic program guide application for receiving and presenting the electronic program guide data and controlling the options that can be performed on the electronic program guide data;
a display for displaying the electronic program guide data and the options that can be performed on the electronic program guide data;
a user interface for accepting input to manipulate the electronic program guide application to navigate among the display screens presented by the electronic program guide application and control the options that can be performed on the electronic program guide data; and
a processor for receiving and processing data pertaining to the electronic program guide and the options that can be performed on the electronic program guide data and sending instructions to the mobile television service provider in response to input used to control the options that can be performed on the electronic program guide data.

10. The portable mobile communications device of claim 9 wherein the options that can be performed on the electronic program guide data include an option to select and record a program locally on the portable mobile communications device.

11. The portable mobile communications device of claim 9 wherein the options that can be performed on the electronic program guide data include an option to select and record a program remotely on the mobile radio access network (MRAN).

12. The portable mobile communications device of claim 9 wherein the options that can be performed on the electronic program guide data include an option to select and record a program remotely on a home personal video recorder (PVR) via an Internet connection among the mobile radio access network (MRAN), the mobile television service provider, and the home PVR.

13. The portable mobile communications device of claim 9 wherein the options that can be applied to the selected program include an option to store the selected program remotely on an Internet storage device via an Internet connection among the mobile radio access network (MRAN), the mobile television service provider, and the home PVR.

14. The portable mobile communications device of claim 9 wherein the options that can be applied to the selected program include an option to store the selected program remotely on a computer via an Internet connection among the mobile radio access network (MRAN), the mobile television service provider, and the home PVR.

15. The portable mobile communications device of claim 9 wherein the options that can be performed on the electronic program guide data include an option to select and set a reminder for a program, the reminder to be displayed, on the display of the portable mobile communications device, at a pre-determined time prior to the scheduled time of broadcast for the selected program.

16. A computer program product for operating an electronic program guide on a portable mobile communications device, the portable mobile communications device communicable with a mobile radio access network (MRAN) and capable of receiving broadcasts from a mobile television service provider, the computer program product comprising:
computer program code for displaying, on the display of the portable mobile communications device, a list of programs available on a channel;
computer program code for accepting input from a user interface that selects one of the programs listed;
computer program code for displaying, on the display of the portable mobile communications device, a list of options that can be applied to the selected program wherein the options provide for multiple means for recording the selected program;
computer program code for accepting input from a user interface that selects one of the options for the selected program; and
computer program code for performing the selected option for the selected program.

17. The computer program product of claim 16 wherein the list of options that can be applied to the selected program includes computer program code for recording the selected program locally on the portable mobile communications device.

18. The computer program product of claim 16 wherein the list of options that can be applied to the selected program includes computer program code for recording the selected program remotely on the mobile radio access network (MRAN).

19. The computer program product of claim 16 wherein the list of options that can be applied to the selected program includes computer program code for recording the selected program remotely on a home personal video recorder (PVR) via an Internet connection among the mobile radio access network (MRAN), the mobile television service provider, and the home PVR.

20. The computer program product of claim 16 wherein the list of options that can be applied to the selected program includes an option to store the selected program remotely on an Internet storage device via an Internet connection among the mobile radio access network (MRAN), the mobile television service provider, and the home PVR.

21. The computer program product of claim 16 wherein the list of options that can be applied to the selected program includes an option to store the selected program remotely on a computer via an Internet connection among the mobile radio access network (MRAN), the mobile television service provider, and the home PVR.

22. The computer program product of claim 16 wherein the list of options that can be applied to the selected program includes computer program code for setting a reminder for the selected program, the reminder to be displayed, on the display of the portable mobile communications device, at a pre-determined time prior to the scheduled time of broadcast for the selected program.
